(19) United States
(12) Patent Application Publication
(10) Pub. No.: US 2023/0392869 A1
(43) Pub. Date: Dec. 7, 2023

(54) 221-0240 HEAT EXCHANGER FOR A VEHICLE

(71) Applicant: Ford Global Technologies, LLC, Dearborn, MI (US)

(72) Inventors: Thomas Nitsche, Neuss (DE); Cliff Pountney, Chelmsford (GB); Igor Golberg, Cologne (DE)

(21) Appl. No.: 18/325,356

(22) Filed: May 30, 2023

(30) Foreign Application Priority Data
Jun. 1, 2022 (DE) 102022113854.2

(51) Int. Cl. F28D 1/053

(52) U.S. Cl. CPC F28D 1/05383; F28D 2001/0266

(57) ABSTRACT

Systems are provided for a heat exchanger having a housing and core elements arranged therein in a stack. A flow path for a first fluid runs through the core elements from a housing inlet opening to a housing outlet opening. The core elements are all oriented in the same direction relative to the housing inlet opening and the housing outlet opening.

### CROSS REFERENCE TO RELATED APPLICATION

The present application claims priority to German Patent Application No. 10 2022 113 854.2 filed on Jun. 1, 2022. The entire contents of the above-listed application is hereby incorporated by reference for all purposes.

### TECHNICAL FIELD

The present description relates generally to a heat exchanger, a heat exchanger assembly, and a vehicle having a heat exchanger or heat exchanger assembly.

### BACKGROUND/SUMMARY

Various devices across a multitude of disciplines demand cooling for optimal performance. Vehicle components, hardware chips, and the like may demand increased cooling to improve performance and efficiency. Thus, innovations to heat exchangers and other temperature regulating devices are demanded.

An example of a heat exchanger is shown in EP 2 947 411 A1, which discloses a heat exchanger for an air conditioning system having a plate-shaped and substantially rectangular core element comprising a plurality of ribs for conducting a coolant. The ribs are angled with respect to an inlet and outlet opening of the core element.

JP 2004 069228 A describes a similar heat exchanger designed for a vehicle.

US 2022/0042690 A1 describes a heat exchanger for a ventilation unit. This comprises a plurality of core elements arranged vertically above one another and within a plane.

U.S. Pat. No. 9,982,898 B2 describes an indoor air conditioning unit that can be mounted, for example, on a wall. The air conditioning unit comprises a heat exchanger with core elements set in a V-shape relative to a fan.

Lastly, EP 0 020 375 B1 discloses a heat exchanger for a vehicle comprising multiple heat exchanger cores. The heat exchanger cores are arranged in a V-configuration to provide an increased frontal surface area. For this purpose, air-guiding ribs, by means of which frontally incoming air can be guided through the legs of the V-shaped structure, are angled with respect to the frontal air inflow. Accordingly, the frontally incoming air must be diverted within the heat exchanger in order to be able to flow through the legs of the V-shaped structure.

In the automotive sector, heat exchangers have become standard over the years, especially in a heat exchanger assembly for engine cooling. Such known heat exchanger assemblies comprise a core element through which air can flow while the vehicle is moving and which can also guide a liquid that is to be cooled separately from the air. For cooling while the vehicle is stationary or driving slowly, a fan is often arranged behind the core element, towards the engine compartment, in order to always allow a sufficiently large air flow through the heat exchanger by suction operation.

However, the relatively small temperature difference between the incoming ambient air and the liquid to be cooled, combined with the large amount of heat to be removed from the liquid to be cooled, has proven to be problematic. Therefore, a large volume flow of ambient air is desired and a correspondingly large cooler surface that comes into contact with the air. This is conventionally achieved by a large front surface area of the core element. However, the demanded front surface area often exceeds the available installation space in the vehicle, because the vehicle height is limited by the overall technical concept of the vehicle and must be utilized for other functional and aesthetic parameters in addition to cooling. In addition, core elements with a large front surface also result in the need for a correspondingly large fan or several fans arranged next to each other, which in addition to requiring additional installation space also reduces the efficiency of the vehicle.

The present disclosure therefore addresses the problem of proposing a heat exchanger for a vehicle which can generate a high heat transfer performance with a small installation space demand and which can be realized efficiently. In one example, the problems described above may be at least partially solved by a system for a heat exchanger including a housing comprising a heat exchanger inflow plane opposite to a heat exchanger outflow plane, with a flow path for a first fluid normal to the heat exchanger inflow plane and the heat exchanger outflow plane, and at least two core elements arranged in a stack along a common axis normal to the flow path of the first fluid, each having a core inflow plane and an opposite core outflow plane, wherein a second fluid flows through an interior volume of the core elements, the interior volume of the core elements defined by surfaces of the core elements, wherein the first fluid is in contact with the surfaces of the core elements and does not enter the interior volume, wherein the core inflow planes and the core outflow planes of the core elements are inclined relative to the heat exchanger inflow plane and heat exchanger outflow plane, wherein an angle of inclination of the core inflow plane and the core outflow plane of at least two adjacent core elements of the stack is identical.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The advantages described herein will be more fully understood by reading an example of an embodiment, referred to herein as the Detailed Description, when taken alone or with reference to the drawings, where:

FIG. 1 shows a core element of a heat exchanger;

FIG. 2 shows a cross-sectional view of a heat exchanger;

FIG. 3 shows a perspective view of a heat exchanger assembly;

FIG. 4 shows a vehicle; and

FIG. 5 shows a heat exchanger with offset core elements.

### DETAILED DESCRIPTION

The following description relates to systems a heat exchanger including a plurality of core elements arranged in a stack. The plurality of core elements may each include surfaces that shape an interior volume. A coolant may flow through the interior volume and ambient air may contact an outer portion of the surfaces such that the ambient air and coolant do not touch or mix. The plurality of core elements may be arranged at an angle relative to a direction of ambient air entering the heat exchanger. Additionally or alternatively, the plurality of core elements may be offset to one another such that a spacing between two or more of the core elements and an inlet and/or an outlet of the heat exchanger is different.

A first embodiment of the disclosure relates to a heat exchanger including a housing having a heat exchanger inflow plane and an opposite heat exchanger outflow plane, with a flow path for a first fluid extending therebetween, and at least two core elements arranged above one another in a stack, each having a core inflow plane and an opposite core outflow plane, which lie in the flow path for the first fluid, wherein a second fluid can flow through the core elements, so that heat transfer between the first fluid and the second fluid is made possible with material separation from the flow path for the first fluid, wherein the core inflow planes and the core outflow planes of the core elements are inclined relative to the heat exchanger inflow plane and heat exchanger outflow plane.

According to the disclosure, it is provided that an angle of inclination of the core inflow plane and the core outflow plane of at least two adjacent core elements of the stack is formed in the same direction.

In other words, at least two core elements arranged directly above one another within the stack are positioned in the same way opposite a housing inlet opening.

This offers the advantage that a surface area of the core elements or the sum of the surface areas of the core elements, which is the first to come into contact with the inflowing first fluid, can be dimensioned much larger than is the case with core elements of conventional heat exchangers which are not inclined in the same direction according to the disclosure, while the size of the heat exchanger inflow plane remains constant. This is provided by the inclination of the core elements in the same direction according to the disclosure, whereby, with constant installation space demands in the stacking direction and compared to a conventional arrangement of the core elements, a significantly higher number of core elements can be arranged in a very dense packing within the stack. The total surface area of the core elements which is the first to come into contact with the inflowing first fluid can thus be scaled up significantly and in particular can be a multiple of the area of the heat exchanger inflow plane. In other words, the demanded installation space in the stacking direction is reduced if, in a conventional heat exchanger, the existing number of core elements is arranged inclined in the same direction according to the disclosure. Here, the disclosure exploits the effect that the extensions of all core elements add up in the stacking direction, so that even a small angle of inclination leads to a large saving in the demanded installation space in the stacking direction. Since the extensions of the core elements do not add up transverse to the stacking direction, the angle of inclination does not lead to a relevant increase in the demanded installation space transverse to the stacking direction. Even a small angle of inclination thus leads to a large saving in the demanded installation space overall. The quantity of core elements can be easily scaled and adapted to the desired heat transfer performance and the available installation space. In this way, the heat exchanger of the disclosure can achieve an extremely high heat transfer performance in terms of installation space. All of this makes the heat exchanger of the disclosure very compact, efficient and flexible. In particular, the high installation-space-related heat transfer performance can be achieved even with small temperature differences of the first and second fluids (“inlet temperature difference (ITD)”). Since each core element is the first to come into contact with the inflowing first fluid (e.g. “first sees air”), there is a maximum ITD at each core element.

It is desired that all core elements are inclined in the same direction for desired utilization of these effects.

The heat exchanger (also called “heat exchanger (HEx)”) of the disclosure is particularly suitable for vehicles, but in principle it can also be used advantageously in other areas, in particular if a high installation-space-related heat transfer performance is desired there with a low temperature difference of the heat-transferring fluids.

The housing of the heat exchanger of the disclosure is shaped to be partially open so that the first fluid can flow into the heat exchanger via the heat exchanger inflow plane and can flow out of the heat exchanger via the heat exchanger outflow plane. Purely by way of example, the housing may be formed by two opposing walls, preferably metal sheets, between which the heat exchanger inflow plane and the heat exchanger outflow plane extend and between which the core elements are arranged. Such a housing may also be referred to as an “open” frame. Preferably, the core elements are attached to at least one wall, preferably to both walls. Particularly preferably, the walls also form an interface through which the second fluid can flow through the core elements. To this end, the walls may also have a box-like shape (also referred to as an “end tank”) into which the second fluid can flow, in order to then flow from there into the core elements. The housing may also have additional walls and may form, for example, a frame running around or “closed” with respect to the stack of core elements.

The heat exchanger inflow plane and the heat exchanger outflow plane each designate a largest possible flow cross-section for the first fluid over which the first fluid can enter or exit the housing. Preferably, the heat exchanger inflow plane can be considered as the intersection of a projection of the core elements onto the housing inlet opening with projections, perpendicular thereto, of the structural elements of the housing surrounding the housing inlet opening in whole or in part. Accordingly, the heat exchanger outflow plane can preferably be viewed as the intersection of the projection of the core elements onto a housing outlet opening with projections, perpendicular thereto, of the structural elements of the housing surrounding the housing outlet opening in whole or in part. Preferably, the heat exchanger inflow plane and the heat exchanger outflow plane are opposite each other in the sense that their perpendicular projections overlap, at least in portions, with the other plane. Preferably, the heat exchanger inflow plane and the heat exchanger outflow plane are arranged substantially parallel to each other.

The first fluid can be, for example, a gas, a liquid, or a mixture. In one example, the first fluid is air, such as ambient air. The second fluid may also be a gas, a liquid, or a mixture. Preferably, the second fluid is a liquid, particularly preferably a liquid to be cooled such as water, cooling water mixture or oil.

In one example, the stack comprises multiple core elements arranged one above the other, for example 3, 4, 5, 6, 7, 8, 9, 10, 11, 12 or more core elements. The specific number is determined in particular by the desired heat transfer performance and the available installation space in the specific application and can be decided by a person skilled in the art.

The core elements can also be referred to as “heat exchanger cores” or “HEx cores”. In one example, they are all of identical shape, size, and function. In some examples, a core element comprises tubular conduit portions for the second fluid and flow passages for the first fluid arranged between them, preferably extending transversely thereto. The flow passages can be implemented, for example, by separation elements, such as ribs or lamellas (also called “fins”), arranged between the tubular conduit portions.

The core inflow plane and the core outflow plane each designate a largest possible flow cross-section for the first fluid, over which the first fluid can enter or exit the core element. In some examples, additionally or alternatively, they can be considered as the largest possible enveloping surface stretched over an inlet or outlet side of the core element. In some examples, additionally or alternatively, the core inflow plane and the core outflow plane of a core element are opposite each other in the sense that their perpendicular projections overlap, at least in portions, with the other plane. In some examples, additionally or alternatively, the core inflow plane and the core outflow plane of a core element are arranged substantially parallel to each other.

The flow path for the first fluid accordingly runs into the heat exchanger via the heat exchanger inflow plane and enters the relevant core elements via the core inflow planes. Then, the flow path for the first fluid passes through the flow passages of the core elements and exits the relevant core element via the core outflow planes. Then, the flow path for the first fluid exits the heat exchanger via the heat exchanger outflow plane. The flow path for the first fluid preferably runs substantially linearly over the heat exchanger as a whole. The flow path for the first fluid within the heat exchanger, via the core elements, is temporarily divided into separate flow paths through the various core elements or their flow passages. Furthermore, a vertical offset of the flow path occurs via the core elements due to their angle of inclination, which corresponds to the degree of inclination of the core elements.

For example, the second fluid can flow through the core elements transversely to the flow path for the first fluid, preferably through the tube-like conduit portions for the second fluid. Since there is no fluidic connection between the flow passages for the first fluid and the tube-like conduit portions for the second fluid, the first and second fluids can only transfer heat to each other but cannot mix materially.

In an embodiment of the heat exchanger of the disclosure, it is provided that the angle of inclination of the adjacent core elements has the same angular value. In other words, the adjacent core elements are arranged parallel to each other or stacked parallel to each other.

This allows for particularly dense packing of the core elements in the stack, thus maximizing the sum of the surface areas of the core elements that come into contact with the incoming first fluid while maintaining a constant size of the heat exchanger inflow plane.

In an embodiment of the heat exchanger of the disclosure, it is provided that the angular value of the angle of inclination is greater than 0° and less than 90°.

Purely for the sake of better illustration, a height direction, a depth direction and a width direction of the stack are first defined as a Cartesian coordinate system by way of example and expediently for the discussion. The height direction corresponds to a direction along the stacked core elements or the stacking direction. The depth direction corresponds to a direction from the heat exchanger inflow plane to the heat exchanger outflow plane, or a main direction of the flow path for the first fluid. The width direction corresponds to a direction in which the core elements extend between the walls of the housing, or a main direction of flow of the second fluid. The definition of the directions can also be adopted accordingly for the housing for reasons of clarity.

For the individual core elements, also purely by way of example for better illustration and expediently for the discussion, a height, width and depth are defined, likewise in terms of a Cartesian coordinate system. The depth of a core element corresponds to its outer dimension in the main direction of the flow path for the first fluid or along the flow passages. The width of a core element corresponds to its outer dimension in the main direction of flow of the second fluid or along the pipe-like conduit portions. Lastly, the height of a core element corresponds to its outer dimension perpendicular to depth and width, for example along several alternately superimposed planes of flow passages and planes of pipe-like conduit portions.

If the above-mentioned angle of inclination is 0°, the extent of a core element in the height direction corresponds to its height, so that no change occurs. If the above-mentioned angle of inclination is 90°, the extent of the core element in the height direction corresponds to its depth. This embodiment falls within the scope of the disclosure and claims therein for the core element a maximum installation space in the depth direction, which corresponds to the height of the core element. In the preferred range between 0° and 90°, in simplified terms, the extent of the core element in the height direction corresponds to the cosine of the angle of inclination multiplied by the height of the core element, and the extent of the core element in the depth direction corresponds to the sine of the angle of inclination multiplied by the height of the core element (neglecting the depth of the core element in the vicinity of 0° and 90°).

Since the extents of all core elements add up in the height direction across the stack and the extents of the core elements do not add up in the depth direction, even a small angle of inclination results in a large saving in the demanded installation space in the height direction and overall.

In some examples, the angles of inclination of 10°, 20°, 30°, 40°, 50°, 60° or 70°, especially in the range of 50° to 60° may be selected, as these have led to particularly enhanced properties of the heat exchanger in tests conducted with regard to the installation-space-related heat transfer performance, the demanded installation space, and the flow conditions.

In a further embodiment of the heat exchanger of the disclosure, it is provided that a spacing between the adjacent core elements in the height direction of the stack is smaller than the height of the adjacent core elements. In other words, without the angle of inclination provided in the disclosure (or with an angle of inclination of 0° or 180°), the core elements would not be stackable on top of each other with the same spacing because they would collide.

Particularly preferably, the spacing between the adjacent core elements in the height direction of the stack is only 1/2, 1/3, 1/4, 1/5, 1/6, 1/7, 1/8, 1/9, 1/10, 1/11 or 1/12 of the height of the adjacent core elements or less.

In a further embodiment of the heat exchanger of the disclosure, it is provided that at least two core elements of the stack are arranged offset from each other in the depth direction of the stack. In other words, an overlap of a projection of the relevant core elements along the height direction of the stack results, but only in portions. Again in other words, it can be said that the relevant core elements are not stacked above in another in a straight line, but in an offset manner, resulting in stack that is skewed, at least in portions.

This offers the advantage that the stack or the heat exchanger of the disclosure can be fitted particularly flexibly into a predefined installation space. In particular, the heat exchanger can thus also be integrated into a surrounding system in a particularly favorable manner in terms of fluidics. For example, embodiments are conceivable in which the heat exchanger is integrated into a radiator arrangement of a vehicle, in which the first fluid is initially guided to the heat exchanger inflow plane via a flow channel of the radiator arrangement. Depending on the installation space situation, the flow channel can, for example, be angled relative to the flow path for the first fluid of the heat exchanger or can feed the first fluid to the heat exchanger in a flow curve. In such cases, the “skewed” stack of the heat exchanger can favor a smoothed transition between the flow channel of the surrounding system and the flow path for the first fluid of the heat exchanger.

In a further embodiment of the heat exchanger of the disclosure, it is provided that the core elements of the stack arranged offset from each other in the depth direction of the stack form an offset profile along a height direction of the stack.

For example, all core elements of the stack can be evenly offset relative to their neighboring core elements, thus forming a linear offset profile. However, other offset profiles are also conceivable, such as offset profiles that are parabolic in portions.

Thus, the flexibility of the heat exchanger of the disclosure is further increased with respect to the use of installation space and fluidic advantageous design.

In a further embodiment of the heat exchanger of the disclosure, it is provided that a flow guide element extends along the core inflow plane of at least one core element of the stack, at least in portions, and guides the first fluid from the heat exchanger inflow plane to the core inflow plane of the core element. Preferably, such a flow guiding element extends along the core inflow plane of all core elements.

In this way, the first fluid flowing into the heat exchanger inflow plane can be guided to the core inflow plane in a particularly favorable manner in terms of fluidics.

In a further embodiment of the heat exchanger of the disclosure, the flow guide element is provided between two adjacent core elements of the stack and blocks the first fluid from flowing from the core outflow plane of one adjacent core element to the core inflow plane of the other adjacent core element.

In this way, a particularly efficient control of the flow path for the first fluid is provide or an undesired mixing of the first fluid before and after the heat transfer is avoided.

A first position is occupied here by an uppermost and a lowermost core element in the stack, in which the core inflow plane or core outflow plane faces directly towards the housing. If the core inflow plane faces the housing directly, the flow guide element preferably extends between the housing and the core element concerned or is formed by the housing. If, on the other hand, the core outflow plane directly faces the housing, the core element is connected to the housing in such a way that the first fluid cannot flow past the core element or can pass from the heat exchanger inflow plane to the heat exchanger outflow plane without flowing through the relevant core element.

In a further embodiment of the heat exchanger of the disclosure, it is provided that the flow guide element extends from an end region of the core outflow plane of one adjacent core element facing the heat exchanger inflow plane to an end region of the core inflow plane of the other adjacent core element facing the heat exchanger outflow plane.

In this way, the flow guide elements can be attached to the adjacent core elements particularly easily and efficiently and optimum flow conditions can be realized.

If the core inflow plane of the relevant core element faces the housing directly, the flow guide element can extend from the housing to the end region of the core inflow plane facing the heat exchanger outflow plane or can be formed by the housing. If the core outflow plane of the relevant core element directly faces the housing, the end region of the core outflow plane located in the direction of the heat exchanger inflow plane can be connected to the housing in such a way that, in turn, the first fluid cannot pass from the heat exchanger inflow plane to the heat exchanger outflow plane without flowing through the relevant core element.

In a further embodiment of the heat exchanger of the disclosure, it is provided that the flow guide element is straight, curved, or meandering, at least in portions. This also includes embodiments with straight, curved or meandering portions in expedient combination.

This allows the flow guide element to be optimized according to various criteria, such as manufacturing efficiency, which is particularly high for straight flow guide elements. In the case of non-straight shapes, such as a curved or meandering shape, the fluidic properties can be designed particularly well.

In a further embodiment of the heat exchanger of the disclosure, it is provided that the flow guide element is curved to provide a flow-efficient shape. In some examples, additionally or alternatively, the angle swept by the curvature corresponds here substantially to the angle of inclination of the core elements.

In a further embodiment of the heat exchanger of the disclosure, it is provided that the flow guide element is S-shaped. The S-shape reduces pressure losses during inflow and outflow of the first fluid into and from the flow guide element. The S-shape is an example of a meandering shape.

In general, it is desired that the flow management can largely take place within the heat exchanger due to the flow guide elements, flow passages and other fluidically shaped structures.

Thus, design complexity and weight of the heat exchanger may be reduced or maintained below a determined value.

In a further embodiment of the heat exchanger of the disclosure, it is provided that the core elements are cuboidal. Such core elements can be arranged particularly well in a stack while realizing the angle of inclination. Conventional core elements often have such a cuboidal shape and could be arranged in a simple manner according to the disclosure or modified beforehand, as discussed below. The term “cuboidal” also includes shapes which, although essentially a cuboid, may be designed to be fluidically enhanced for the present application. For example, the edge regions of the cuboid can be shaped in a fluidically desirable manner, for example rounded, in order to reduce pressure losses, for example, when flowing towards and away from the edge.

In a further embodiment of the heat exchanger of the disclosure, the core elements comprise at least one flow passage for the first fluid from the core inflow plane through the core element to the core outflow plane, wherein the flow passage is inclined relative to the core inflow plane and the core outflow plane such that the angle of inclination of the core inflow plane and the core outflow plane relative to the heat exchanger inflow plane and heat exchanger outflow plane is at least partially compensated. In one example, the inclination of the flow passage corresponds to the angle of inclination.

In this way, the flow path for the first fluid is smoothed or the step in the flow path over the core elements is reduced. As a result, the flow path approaches its desired linear course. This creates particularly favorable flow conditions and reduces pressure losses, so that the heat exchanger is particularly efficient.

Alternatively, the flow passage might not be inclined relative to the core inflow plane and the core outflow plane and might extend perpendicularly to them, for example, which allows particularly efficient production.

The sum of the area of the core inflow planes of all core elements is a multiple of the area of the heat exchanger inflow plane, thus making the heat exchanger of the disclosure scalable in a flexible way.

The “multiple” can be expressed by a scaling factor greater than 1, which can be determined by a person skilled in the art on the basis of the desired heat transfer performance. The scaling factor can, for example, be selected as 1.1 or increased in steps of, for example, 0.1 up to 1.9.

In a further embodiment of the heat exchanger of the disclosure, it is provided that the sum of the areas of the core inflow planes of all core elements is at least twice as large (the scaling factor here would be 2) as the area of the heat exchanger inflow plane. In one example, the sum of the areas of the core inflow planes is three times, four times or five times as large, or even larger.

The heat exchanger of the disclosure can be manufactured in a variety of ways, for example by welding, soldering, using fasteners such as screws or rivets, or by additive manufacturing processes.

Another aspect of the disclosure relates to a heat exchanger assembly including a heat exchanger, a turbomachine operatively connected to a flow path for a first fluid running through the heat exchanger, and a source of a second fluid, which is operatively connected to core elements of the heat exchanger.

The turbomachine is operatively connected to the flow path for the first fluid in such a way that its suction or pressure can act on the flow path for the first fluid and can convey the first fluid. It may be designed for suction operation, for example by arranging the turbomachine upstream of the heat exchanger outflow plane. The turbomachine may be, for example, a fan or a pump, depending on the type of first fluid.

Since the installation-space-related heat transfer performance of the heat exchanger of the disclosure is high, the heat exchanger outflow plane can be sized to use only a single turbomachine of efficient size.

The source of the second fluid can, for example, be operatively connected to the core elements of the heat exchanger via a housing of the heat exchanger. It can actively convey the second fluid through the heat exchanger, i.e. by generating suction or pressure.

In a further embodiment of the heat exchanger assembly of the disclosure, it is provided that this is configured as a radiator assembly for a vehicle.

In one example, the first fluid is the ambient air and the second fluid is cooling liquid, such as cooling water or oil. In some examples, additionally or alternatively, a fan arranged in front of the heat exchanger outflow plane serves as the turbomachine. A cooling system of the vehicle preferably serves as the source of the second fluid.

Another aspect of the disclosure relates to a vehicle comprising a heat exchanger assembly according to the disclosure as per the present disclosure and/or a heat exchanger according to the disclosure as per the present disclosure.

The vehicle is a motor vehicle, such as a passenger car or lorry. The cooling system of the vehicle can be an engine cooling system. Due to the high installation-space-related heat transfer performance and thus cooling capacity, the vehicle can in particular also be a vehicle with a fuel cell, which is cooled with the cooling system.

In one example, the present disclosure relates to a heat exchanger having a housing and core elements arranged therein in a stack. A flow path for a first fluid extends through the core elements from a housing inlet opening to a housing outlet opening. The core elements are all oriented in the same direction relative to the housing inlet opening and the housing outlet opening. The disclosure further relates to a heat exchanger assembly comprising the heat exchanger, and a vehicle comprising the heat exchanger assembly.

In one embodiment, all features disclosed herein with reference to certain aspects or embodiments may also be combined in a technically expedient manner with other aspects or embodiments of the disclosure. This applies in particular also in part for individual features, as long as it is not explicitly pointed out herein or obvious by way of a technical contradiction that there is an inseparable functional-technical relationship between certain features which must be maintained in order to carry out the disclosure.

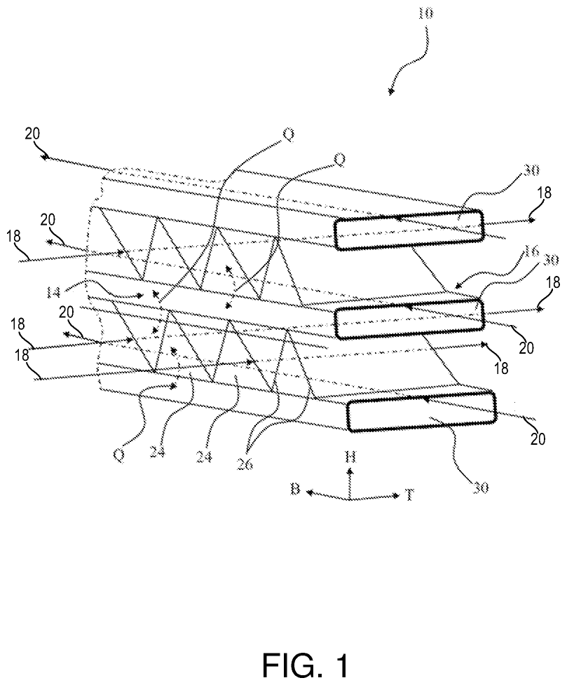

FIGS. 1-5 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. It will be appreciated that one or more components referred to as being “substantially similar and/or identical” differ from one another according to manufacturing tolerances (e.g., within 1-5% deviation). FIGS. 1-3 are shown approximately to scale. Other dimensions may be used if desired.

FIG. 1 shows a core element 10 or an HEx core of a heat exchanger 12 or an Hex. The core element 10 comprises a core inflow plane 14 and an opposite, preferably substantially parallel, core outflow plane 16, between which a first fluid 18 can flow through the core element 10. At the same time, a second fluid 20 can flow through the core element 10 while being materially separated from the first fluid 18. Thus, a heat transfer Q can take place between the first fluid 18 and the second fluid 20, but no material mixing. That is to say, the first fluid 18 is completely separated from the second fluid 20 and does not mix with the second fluid 20 despite being thermally coupled thereto.

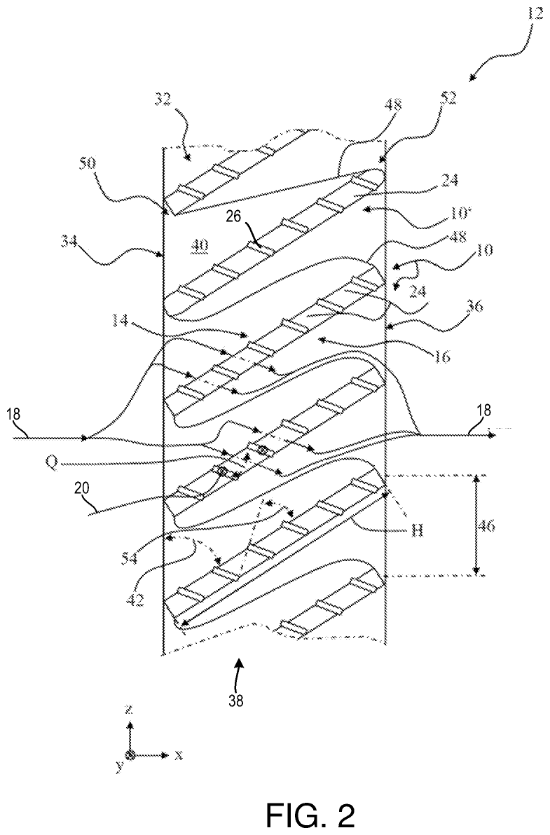

In this example, the core element 10 includes a cuboidal shape. The term “cuboidal” also includes shapes that are essentially a cuboid, but may have lower-order geometric elements (e.g. edges) that contribute to a deviation from the cuboid shape (cf. also FIG. 2). Purely for ease of illustration and convenience of discussion, the core element 10 has a height H, width B and depth T in the sense of a Cartesian coordinate system.

The depth T of the core element 10 corresponds to its outer dimension in the main direction of a flow path for the first fluid 18 (cf. also FIGS. 2 to 4). For this purpose, the core element 10 has flow passages 24 which define the flow path for the first fluid 18 through the core element 10 from the core inflow plane 14 to the core outflow plane 16. The flow passages 24 are realized by way of example by separation elements 26 in the form of ribs or fins.

The width B of the core element 10 corresponds to its outer dimension in the main direction of flow of the second fluid 28. For this purpose, the core element 10 preferably has tubular conduit portions 30 which define the main direction of flow of the second fluid 20 through the core element 10.

Lastly, the height H of the core element 10 corresponds to its outer dimension perpendicular to its depth T and width B, in this example along several planes of flow passages 24 and planes of tubular conduit portions 30 arranged one above the other in alternation.

The core element 10 is only partially shown in FIG. 1 over its width B and can be scaled over the width B, the height H and the depth T.

FIG. 2 shows a cross-sectional view of the heat exchanger 12. The heat exchanger 12 comprises a housing 32 having a heat exchanger inflow plane 34 and an opposite, substantially parallel, heat exchanger outflow plane 36. Between the heat exchanger inflow plane 34 and the heat exchanger outflow plane 36 there extends the flow path for the first fluid 22.

Multiple core elements 10, which may be formed as described in FIG. 1, are provided in the housing 32 one above the other in a stack 38. For ease of illustration, a height direction z, a depth direction x, and a width direction y of the stack 38 are defined below as a Cartesian coordinate system for convenience of discussion.

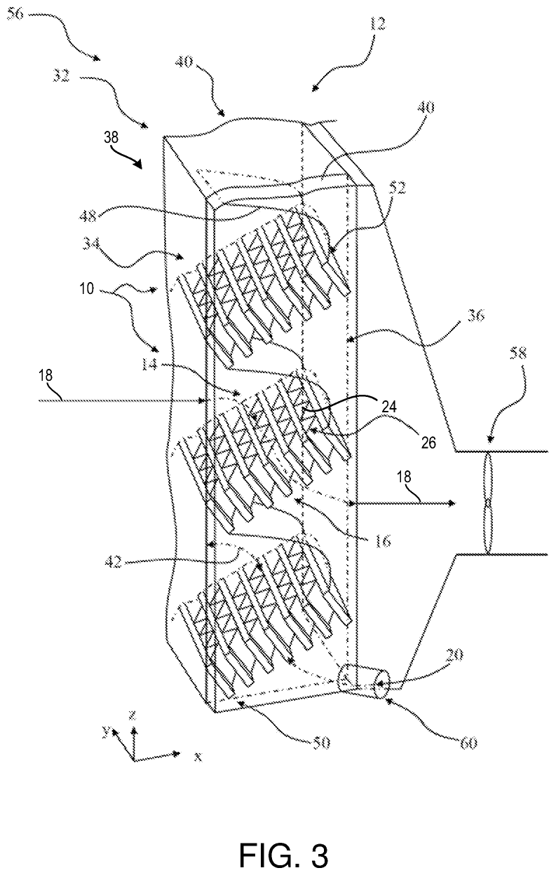

The height direction z corresponds to a direction along the core elements 10 stacked above one another or to the stacking direction. The depth direction x corresponds to a direction from the heat exchanger inflow plane 34 to the heat exchanger outflow plane 36 or a main direction of the flow path for the first fluid 22. The width direction y corresponds to a direction in which the core elements 10 extend between walls 40 of the housing 32, of which only one wall 40 is illustrated in FIG. 2 (cf. also FIG. 3), or corresponds to the main direction of flow of the second fluid 20 (cf. also FIG. 1). The definition of these directions of the stack 38 applies here correspondingly for the housing 32 for the sake of clarity.

As already mentioned with reference to FIG. 1, the flow path for a first fluid 22, after entry via the heat exchanger inflow plane 34 of the heat exchanger 12, continues via the core inflow plane 14 and the core outflow plane 16 through the core elements 10 of the stack 38, in order to then flow out of the heat exchanger 12 via the heat exchanger outflow plane 36. At the same time, the second fluid 20 can flow through the core elements 10 so that heat transfer Q between the first fluid 18 and the second fluid 20 is made possible with material separation from the flow path for the first fluid 22.

It should be noted that the flow path for the first fluid 18 in FIG. 2 is broken down into individual arrows merely for reasons of clarity, and is not illustrated for each core element 10. In reality, the flow path for the first fluid 18 may enter the heat exchanger inflow plane 34 and exit the heat exchanger outflow plane 36 as a flow front. Within the heat exchanger 12, through the core elements 10, the temporary division into partial flow paths illustrated in the form of the branched arrows may occur.

FIG. 2 shows that the core inflow planes 14 and the core outflow planes 16 of the core elements 10 are inclined relative to the heat exchanger inflow plane 34 and heat exchanger outflow plane 36, and a corresponding angle of inclination 42 is formed. The angle of inclination 42 is illustrated by way of example with respect to two adjacently arranged core elements 10 and the heat exchanger inflow plane 34. In this example, since the heat exchanger inflow plane 34 and the heat exchanger outflow plane 36 as well as the core inflow plane 14 and the core outflow plane 16 are arranged parallel to each other, respectively, the angle of inclination 42 exists between the core inflow plane 14 and the core outflow plane 16 with respect to the heat exchanger inflow plane 34 and the heat exchanger outflow plane 36, respectively.

In particular, the angle of inclination 42 of the core inflow plane 14 and the core outflow plane 16 of at least two adjacent core elements 10 of the stack 38, and in the illustrated example of all core elements 10 of the stack 38, is configured in the same direction.

In this way, the core elements 10 of the stack 38 can be packed densely in the height direction z, which reduces the demanded installation space for the heat exchanger 12 in the height direction z. At the same time, the sum of the areas of all core inflow planes 14, to which the first fluid 18 can flow directly, is a multiple of the area of the heat exchanger inflow plane 34. The heat exchanger 12 can therefore provide a high installation-space-related heat transfer performance.

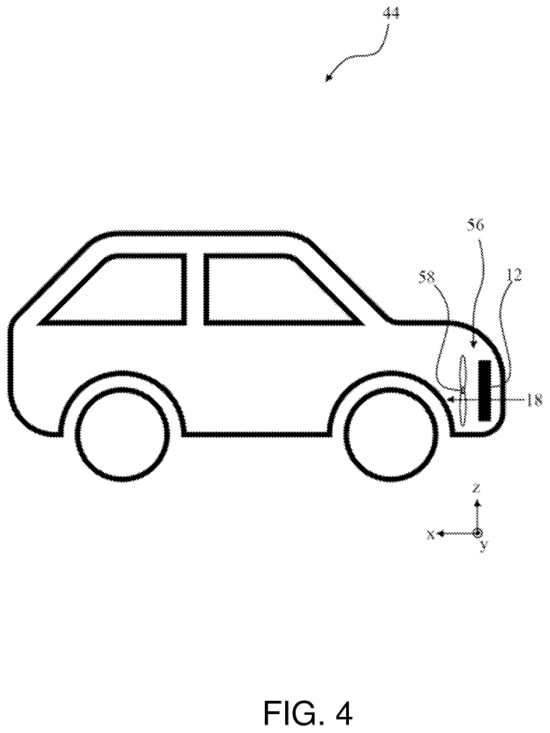

The stack 38 and the housing 32 are shown only in portions in the height direction z and can be scaled as desired, depending on the available installation space of a surrounding system such as a vehicle 44 (not shown here, cf. FIG. 4).

In this example, the angle of inclination 42 of all core elements 10 has the same angular value, which is here about 60°, for example. Thus, which would also be the case with other angular amounts, a spacing 46 of the adjacent core elements 10 in the height direction z of the stack 38 can be significantly smaller than the height H (cf. FIG. 1) of the adjacent core elements 10.

In FIG. 2, it can be seen that a flow guide element 48 extends in portions along the core inflow plane 14 of the core elements 10 of the stack 38 and guides the first fluid 18 from the heat exchanger inflow plane 34 to the core inflow planes 14 of the core elements 10. The flow guide element 48 extends between each two adjacent core elements 10 of the stack 38, thereby also effectively blocking the first fluid 18 from flowing from the core outflow plane 16 of an adjacent core element 10 to the core inflow plane 14 of another adjacent core element 10. In this example, the flow guide element 48 extends in each case from an end region of the relevant core outflow plane 50 of an adjacent core element 10 facing the heat exchanger inflow plane 34 to an end region of the core inflow plane 52 of an adjacent core element 10 facing the heat exchanger outflow plane 36.

To improve the flow conditions, one or more flow guide elements 48 can be curved (cf. also FIG. 3) or meandering. In the example of FIG. 2, the flow guide elements 48 are meandering and specifically have an S-shaped form, such as a serpentine shape.

A possible straight form that can be implemented alternatively for one or more flow guide elements 48 is illustrated in FIG. 2 with respect to an exemplary core element 10′. Thus, a straight flow guide element 48 is shown at the end region of the core inflow plane 52 of the exemplary core element 10′ and can be manufactured particularly efficiently.

Also on the basis of the exemplary core element 10′, it can be seen in FIG. 2 that the end region of the core inflow plane 52 and the end region of the core outflow plane 50 can be rounded to allow better inflow and outflow of a first fluid 18.

The configuration options shown with respect to the exemplary core element 10′ can also be applied to further or all core elements 10. Likewise, the exemplary core element 10′ together with its associated flow guide element 48 can be shaped like the other core element 10 and flow guide elements 48 shown in FIG. 2.

In order to achieve a more efficient course of the flow path for the first fluid 18 with as little pressure loss as possible despite the formed angle of inclination 42, the flow passages 24 for the first fluid 18 are preferably arranged at an inclination relative to the core inflow plane 14 and the core outflow plane 16 of the core elements 10 and are thus formed in FIG. 2 differently from the illustration in FIG. 1. An inclination 54 of the flow passages 24 is dimensioned here such that the angle of inclination 42 of the core inflow plane 14 and the core outflow plane 16 relative to the heat exchanger inflow plane 34 and heat exchanger outflow plane 36 is at least partially compensated. This approximates the flow path for the first fluid 18 to a linear course.

In some examples, additionally or alternatively, as shown in FIG. 2, the separation elements 26 are integrated flush with the core inflow plane 14 and the core outflow plane 16 or open into these planes. A corresponding configuration can also be seen at the separation elements 26 in FIGS. 1 and 3.

FIG. 3 shows a perspective view of a heat exchanger assembly 56 with a heat exchanger 12, for example as described in FIG. 2. In one example, it is illustrated here that the previously described inclination 54 of the flow passages 24 can also be dispensed with in order to make the manufacture of the core elements 10 more efficient.

A turbomachine 58 is disposed upstream of the heat exchanger outflow plane 36, and is capable of conveying the first fluid 18 through the flow path for the first fluid 18.

Further, the housing 32 is shown in greater detail and comprises one wall 40 and another wall 40 which is opposite thereto in the width direction y and which is merely indicated. The one wall 40 has an inflow port 60 for the second fluid 20. To allow the second fluid 20 to flow into the wall 40, the wall 40 is preferably hollow, i.e. embodied as a tank. The other wall 40, which is only indicated, is preferably formed accordingly and comprises a discharge port, not shown, for the second fluid 20. The core elements 10 of the stack 38 are preferably connected to the walls 40 and are supplied with the second fluid 20 via the walls.

The source of the second fluid 20 may be, for example, a cooling system of a vehicle 44, said cooling system not being shown here and being operatively connected to the core elements of the heat exchanger 12 via the housing 32.

FIG. 3 also illustrates that the core inflow planes 14 and the core outflow planes 16 of the core elements 10 of the stack 38 are inclined relative to the heat exchanger inflow plane 34 and heat exchanger outflow plane 36, such that the angle of inclination 42 of the core inflow planes 14 and the core outflow planes 16 of the core elements 10 is formed in the same direction.

FIG. 3 also shows that the flow guide element 48, which is arranged in front of the core inflow plane 14 of the upper core element 10 in the stack 38 in the height direction z, can be connected to the housing 32, by way of example. The flow guide element 48, for example, may extend from the housing 32 to the end region of the core inflow plane 52 of the upper core element facing the heat exchanger outflow plane 36. In the example of FIG. 3, the flow guide elements 48 are curved. In the case of the lower core element 10 in the stack 38 in the height direction z, this core element, by way of example, may be directly connected to the housing 32. For example, an end region of the core outflow plane 50 of the lower core element 10 facing the heat exchanger inflow plane 34 may be connected to the housing 32.

FIG. 4 shows a vehicle 44 with a heat exchanger assembly 56, for example as described in FIG. 3. The heat exchanger assembly 56 is shown here by way of example configured as a radiator arrangement for the vehicle 44. Illustrated in FIG. 4 are the arrangement of the heat exchanger 12 and the turbomachine 58 as well as the course of the flow path for the first fluid 22.

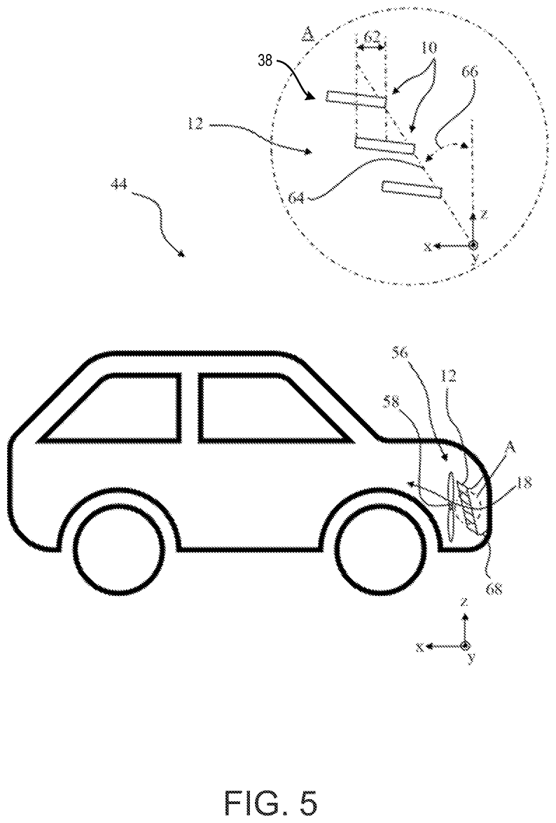

FIG. 5 shows a vehicle 44 with a heat exchanger assembly 56, which may be substantially similar to FIG. 4, and therefore only the differences are discussed here. The heat exchanger assembly 56 in FIG. 5 also comprises a heat exchanger 12, which is shown in part in greater detail in the detail A. The heat exchanger 12 may otherwise be embodied in accordance with the other disclosed embodiments, unless otherwise described herein.

In FIG. 5, however, at least two core elements 10 of the stack 38, in the example shown here even all core elements 10, are arranged offset to each other in the depth direction x of the stack 38, so that an overlap 62 of a projection of the relevant core elements 10 along the height direction z of the stack 38 is provided only in portions. The core elements 10 are thus stacked on top of each other in an offset manner. As a result of this offset, the core elements 10 offset relative to one another in the depth direction x of the stack 38 form an offset profile 64 along the height direction z. The offset profile 64, which is linear here purely by way of example, allows individual installation space adaptation.

The linear offset profile 64 runs at an angle 66 relative to the height direction z of the stack 38. In the lower part of FIG. 5, it can be seen that the heat exchanger 12 is integrated in the radiator arrangement of the vehicle 44, wherein the first fluid 18 is first directed to the heat exchanger 12 via a flow channel 68. Here, the flow path for the first fluid 18 of the heat exchanger 12 describes a flow curve, as can be seen in FIG. 5.

The shown arrangement of the core elements 10, in the manner of a “skewed” stack 38 forming the angle 66 also permits a smoothing of the flow curve in this case and ensures a fluidically favorable transition from the flow channel 68 to the heat exchanger 12.

In one example, the disclosure provides support for a heat exchanger including at least one stack comprising two or more core elements through which a fluid or mixture of fluids may flow. In one example, coolant, or a similar type of fluid may flow, may flow through an interior volume. The core elements may include separating elements, such as fins, that are physically coupled to neighboring core elements of the stack. Ambient air and/or another gas directed to the engine may be directed through gaps between the fins and the core elements.

The stack may include the core elements arranged along a common axis such that each of the core elements is aligned with the common axis. Ambient air may flow normal to the common axis. Coolant may flow normal to the common axis. A thickness of the core elements may be normal to the common axis and parallel to the direction of ambient air flow.

In another examples, the core elements may be staggered about a plane along which the core elements are arranged. For example, each of the core elements may be spaced unevenly from an inlet of the heat exchanger and an outlet of the heat exchanger. Additionally or alternatively, the core elements may be angled to the direction of ambient air flow and staggered about the plane.

The disclosure provides support for a heat exchanger including a housing comprising a heat exchanger inflow plane opposite to a heat exchanger outflow plane, with a flow path for a first fluid normal to the heat exchanger inflow plane and the heat exchanger outflow plane, at least two core elements arranged in a stack along a common axis normal to the flow path of the first fluid, each having a core inflow plane and an opposite core outflow plane, wherein a second fluid flows through an interior volume of the core elements, the interior volume of the core elements defined by surfaces of the core elements, wherein the first fluid is in contact with the surfaces of the core elements and does not enter the interior volume, the core inflow planes and the core outflow planes of the core elements are inclined relative to the heat exchanger inflow plane and heat exchanger outflow plane, wherein an angle of inclination of the core inflow plane and the core outflow plane of at least two adjacent core elements of the stack is identical. A first example of the heat exchanger further includes where the angle of inclination is measured along the common axis and an angle at which the core elements are arranged. A second example of the heat exchanger, optionally including the first example, further includes where the angle of inclination is greater than 0° and less than 90°. A third example of the heat exchanger, optionally including one or more of the previous examples, further includes where a height of a spacing between the adjacent core elements in a height direction, parallel to the common axis, of the stack is smaller than a height of each of the core elements. A fourth example of the heat exchanger, optionally including one or more of the previous examples, further includes where at least two core elements of the stack are arranged offset from each other in a depth direction of the stack, wherein the depth direction is parallel to the flow path for the first fluid and normal to the common axis. A fifth example of the heat exchanger, optionally including one or more of the previous examples, further includes where the core elements of the stack arranged offset from each other in the depth direction of the stack comprise an offset profile along a height direction of the stack, wherein the offset profile is linear or parabolic. A sixth example of the heat exchanger, optionally including one or more of the previous examples, further includes where a flow guide element extends along the core inflow plane of at least one core element of the stack, at least in portions, and guides the first fluid from the heat exchanger inflow plane to the heat exchanger outflow plane. A seventh example of the heat exchanger, optionally including one or more of the previous examples, further includes where the flow guide element is provided between two adjacent core elements of the stack and prevents the first fluid from flowing from the core outflow plane of one adjacent core element to the core inflow plane of the other adjacent core element. An eighth example of the heat exchanger, optionally including one or more of the previous examples, further includes where the flow guide element extends from an end region of the core outflow plane of one adjacent core element facing the heat exchanger inflow plane to an end region of the core inflow plane of the other adjacent core element facing the heat exchanger outflow plane. A ninth example of the heat exchanger, optionally including one or more of the previous examples, further includes where the flow guide element is straight, curved, or zig-zagged at least in portions. A tenth example of the heat exchanger, optionally including one or more of the previous examples, further includes where the core elements are cuboidal.

The disclosure provides additional support for a system including a heat exchanger comprising a housing comprising a heat exchanger inflow plane opposite to a heat exchanger outflow plane, with a flow path for a first fluid normal to the heat exchanger inflow plane and the heat exchanger outflow plane, at least two core elements arranged in a stack along a common axis normal to the flow path of the first fluid, each having a core inflow plane and an opposite core outflow plane, wherein a second fluid flows through an interior volume of the core elements, the interior volume of the core elements defined by surfaces of the core elements, wherein the first fluid is in contact with the surfaces of the core elements and does not enter the interior volume, the core inflow planes and the core outflow planes of the core elements are inclined relative to the heat exchanger inflow plane and heat exchanger outflow plane, wherein an angle of inclination of the core inflow plane and the core outflow plane of at least two adjacent core elements of the stack is identical, and a turbomachine positioned downstream of the heat exchanger outflow plane relative to the flow path of the first fluid, and wherein the turbomachine is configured to receive the first fluid. A first example of the system further includes where the core elements comprise at least one flow passage for the first fluid from the core inflow plane, through the core element, to the core outflow plane, wherein the flow passage is inclined relative to the core inflow plane and the core outflow plane such that the angle of inclination of the core inflow plane and the core outflow plane relative to the heat exchanger inflow plane and heat exchanger outflow plane is at least partially compensated. A second example of the system, optionally including the first example, further includes where the heat exchanger is a radiator of a vehicle. A third example of the system, optionally including one or more of the previous examples, further includes where the first fluid is different than the second fluid.

The disclosure provides further support for a system including a heat exchanger comprising a plurality of core elements through which a coolant flows in a first direction, a separator element physically coupled to neighboring core elements of the plurality of core elements, wherein the separator elements shapes a plurality of flow paths through which ambient air flows. A first example of the system further includes where the plurality of core elements is angled relative to a direction of ambient air flow entering the heat exchanger. A second example of the system, optionally including the first example, further includes where the plurality of core elements is misaligned relative to an axis parallel to a height of each of the plurality of core elements. A third example of the system, optionally including one or more of the previous examples, further includes where the plurality of core elements is parallel to a plane, and wherein a direction of ambient air flow through the heat exchanger is angled to the plane. A fourth example of the system, optionally including one or more of the previous examples, further includes where each the plurality of core elements is spaced differently from an inlet of the heat exchanger and an outlet of the heat exchanger.

Note that the example control and estimation routines included herein can be used with various engine and/or vehicle system configurations. The control methods and routines disclosed herein may be stored as executable instructions in non-transitory memory and may be carried out by the control system including the controller in combination with the various sensors, actuators, and other engine hardware. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily demanded to achieve the features and advantages of the example embodiments described herein, but is provided for ease of illustration and description. One or more of the illustrated actions, operations and/or functions may be repeatedly performed depending on the particular strategy being used. Further, the described actions, operations and/or functions may graphically represent code to be programmed into non-transitory memory of the computer readable storage medium in the engine control system, where the described actions are carried out by executing the instructions in a system including the various engine hardware components in combination with the electronic controller.

It will be appreciated that the configurations and routines disclosed herein are exemplary in nature, and that these specific embodiments are not to be considered in a limiting sense, because numerous variations are possible. For example, the above technology can be applied to V-6, I-4, I-6, V-12, opposed 4, and other engine types. The subject matter of the present disclosure includes all novel and non-obvious combinations and sub-combinations of the various systems and configurations, and other features, functions, and/or properties disclosed herein.

As used herein, the term “approximately” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A heat exchanger, comprising:
a housing comprising a heat exchanger inflow plane opposite to a heat exchanger outflow plane, with a flow path for a first fluid normal to the heat exchanger inflow plane and the heat exchanger outflow plane; and
at least two core elements arranged in a stack along a common axis normal to the flow path of the first fluid, each having a core inflow plane and an opposite core outflow plane, wherein a second fluid flows through an interior volume of the core elements, the interior volume of the core elements defined by surfaces of the core elements, wherein the first fluid is in contact with the surfaces of the core elements and does not enter the interior volume; wherein
the core inflow planes and the core outflow planes of the core elements are inclined relative to the heat exchanger inflow plane and heat exchanger outflow plane, wherein an angle of inclination of the core inflow plane and the core outflow plane of at least two adjacent core elements of the stack is identical.

2. The heat exchanger of claim 1, wherein the angle of inclination is measured along the common axis and an angle at which the core elements are arranged.

3. The heat exchanger of claim 1, wherein the angle of inclination is greater than 0° and less than 90°.

4. The heat exchanger of claim 1, wherein a height of a spacing between the adjacent core elements in a height direction, parallel to the common axis, of the stack is smaller than a height of each of the core elements.

5. The heat exchanger of claim 1, wherein at least two core elements of the stack are arranged offset from each other in a depth direction of the stack, wherein the depth direction is parallel to the flow path for the first fluid and normal to the common axis.

6. The heat exchanger of claim 5, wherein the core elements of the stack arranged offset from each other in the depth direction of the stack comprise an offset profile along a height direction of the stack, wherein the offset profile is linear or parabolic.

7. The heat exchanger of claim 1, wherein a flow guide element extends along the core inflow plane of at least one core element of the stack, at least in portions, and guides the first fluid from the heat exchanger inflow plane to the heat exchanger outflow plane.

8. The heat exchanger of claim 7, wherein the flow guide element is provided between two adjacent core elements of the stack and prevents the first fluid from flowing from the core outflow plane of one adjacent core element to the core inflow plane of the other adjacent core element.

9. The heat exchanger of claim 8, wherein the flow guide element extends from an end region of the core outflow plane of one adjacent core element facing the heat exchanger inflow plane to an end region of the core inflow plane of the other adjacent core element facing the heat exchanger outflow plane.

10. The heat exchanger of claim 7, wherein the flow guide element is straight, curved, or zig-zagged at least in portions.

11. The heat exchanger of claim 1, wherein the core elements are cuboidal.

12. A system, comprising:
a heat exchanger comprising a housing comprising a heat exchanger inflow plane opposite to a heat exchanger outflow plane, with a flow path for a first fluid normal to the heat exchanger inflow plane and the heat exchanger outflow plane;
at least two core elements arranged in a stack along a common axis normal to the flow path of the first fluid, each having a core inflow plane and an opposite core outflow plane, wherein a second fluid flows through an interior volume of the core elements, the interior volume of the core elements defined by surfaces of the core elements, wherein the first fluid is in contact with the surfaces of the core elements and does not enter the interior volume; wherein
the core inflow planes and the core outflow planes of the core elements are inclined relative to the heat exchanger inflow plane and heat exchanger outflow plane, wherein an angle of inclination of the core inflow plane and the core outflow plane of at least two adjacent core elements of the stack is identical; and
a turbomachine positioned downstream of the heat exchanger outflow plane relative to the flow path of the first fluid, and wherein the turbomachine is configured to receive the first fluid.

13. The system of claim 12, wherein the core elements comprise at least one flow passage for the first fluid from the core inflow plane, through the core element, to the core outflow plane, wherein the flow passage is inclined relative to the core inflow plane and the core outflow plane such that the angle of inclination of the core inflow plane and the core outflow plane relative to the heat exchanger inflow plane and heat exchanger outflow plane is at least partially compensated.

14. The system of claim 12, wherein the heat exchanger is a radiator of a vehicle.

15. The system of claim 12, wherein the first fluid is different than the second fluid.

16. A system, comprising:
a heat exchanger comprising a plurality of core elements through which a coolant flows in a first direction; and
a separator element physically coupled to neighboring core elements of the plurality of core elements, wherein the separator elements shapes a plurality of flow paths through which ambient air flows.

17. The system of claim 16, wherein the plurality of core elements is angled relative to a direction of ambient air flow entering the heat exchanger.

18. The system of claim 16, wherein the plurality of core elements is misaligned relative to an axis parallel to a height of each of the plurality of core elements.

19. The system of claim 16, wherein the plurality of core elements is parallel to a plane, and wherein a direction of ambient air flow through the heat exchanger is angled to the plane.

20. The system of claim 16, wherein each the plurality of core elements is spaced differently from an inlet of the heat exchanger and an outlet of the heat exchanger.
